(19) United States
(12) Patent Application Publication
(10) Pub. No.: US 2017/0049086 A1
(43) Pub. Date: Feb. 23, 2017

(54) DUAL BARB FISH HOOK

(71) Applicant: Jess Meyers Lee, Wittmann, AZ (US)

(72) Inventor: Jess Meyers Lee, Wittmann, AZ (US)

(21) Appl. No.: 14/829,609

(22) Filed: Aug. 18, 2015

(51) Int. Cl. A01K 83/00

(52) U.S. Cl. CPC A01K 83/00

(57) ABSTRACT

A fishhook with two barbs. The two barbs are attached to either side of the hook, and are intended to prevent a hook from returning through the opening created upon initial penetration of the tissue of a fish. The barb placement, on either side of the hook, and an increased barb length provide a deeper penetration and wider contact area making it more difficult to dislodge the hook while recovering a hooked fish.

### BACKGROUND OF THE INVENTION

1. Field of Invention

The Invention relates to the field of sport and recreational fishing. Specifically the invention comprises a dual barbed hook in which the barbs, placed side by side, enhance the function of a conventional hook.

2. Description of the Related Art

A large variety of barbed and multi barbed fish hooks have been designed, proposed or patented, and many are available for use when fishing. Many of these feature either on small barb placed near the point of the hook, or two small barbs placed in tandem with one close to the point of the hook and a second placed “in-line” on the shaft between the point and bend of a common hook. U.S. Pat. No. 5,214,875A Multiple Barb Fish Hook, 523988 Fish Hook describe variations of an “inline” barb placement along the shaft near the point of the hook. U.S. Pat. No. 4,757,634A Fish Hook, describes a fishhook with a movable “U” shaped barb feature near the tip. U.S. Pat No. 8,425,94A describes a dual barb fish hook where the barbs are located on the inside of the point facing the shank.

This invention seeks to improve upon these hook designs and provide a more secure engagement to the tissue of a fish by positioning the barbs on either side of the shaft angled with a slight bend toward the shank. This positioning provides for a longer barb capable of penetrating more deeply into the tissue of the fish, while maintaining the strength of the hook.

### BRIEF SUMMARY OF THE PRESENT INVENTION

The present invention comprises features a common fish hook with an eye, shank and bend that combined with two barbs of a predetermined and equal length positioned on the either side of the hook shaft near the point. This invention is related more specifically to the placement of the barbs in relation to the point and bend of the hook. Specifically, to each side of the point at the tip of the hook. This barb placement can be applied to any common hook type including single, double, or treble hooks, provide for longer curved barbs making a firm implantation in a fish more likely.

### BRIEF DESCRIPTION OF THE SEVERAL VIEWS OF THE DRAWINGS

FIG. 1 is a greatly enlarged full side view of the fish hook showing the present invention

FIG. 2 is a greatly enlarged perspective view of the demonstrating the placement of the two barbs relative to the point of the invention.

FIG. 3. Is a greatly enlarged frontal view demonstrating the placement of the two barbs relative each other and to the point of the fish hook

FIG. 4 is an enlarged “top-down” view of the point of the hook demonstrating the barb placement in relation to the point of the hook.

### REFERENCE NUMERALS IN THE DRAWINGS

1 Eye
2 Shank
3 Bend
4 Point
5 Barb #1
6 Barb #2

Reference numbers 1-4 represent common fish hook features and are used to represent the relation of the invention to the current standard hook:

### DETAILED DESCRIPTION OF INVENTION

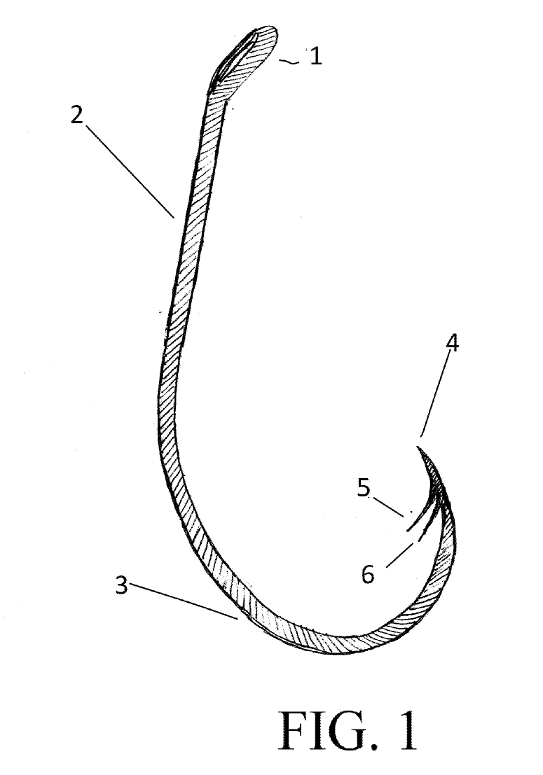

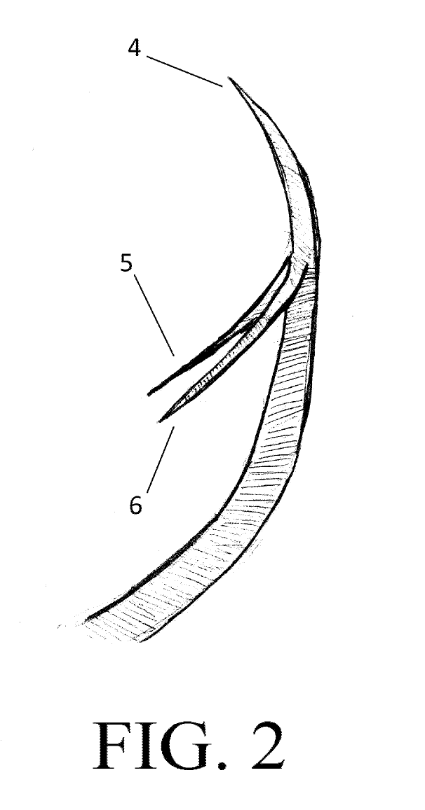

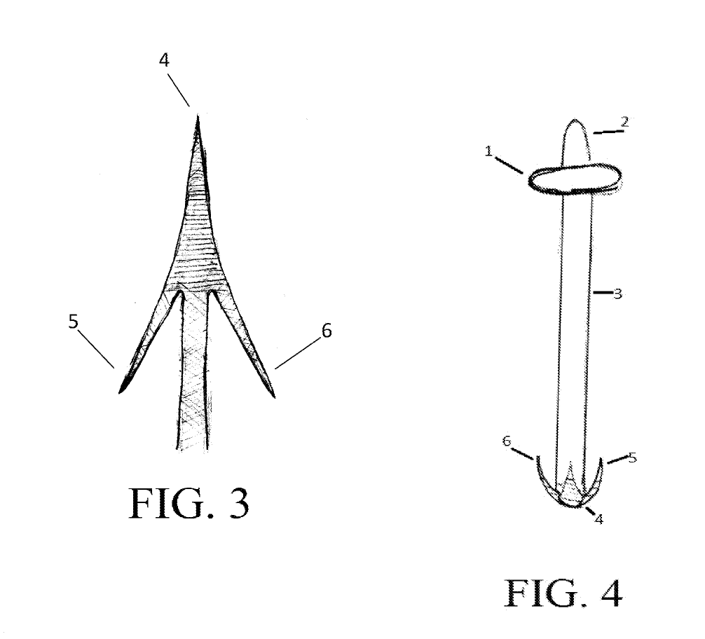

FIG. 1 shows an enlarged view of a common fish hook featuring an eye 1, shank 2, bend 3, point 4 and two barbs 5 & 6. The two barbs 5 & 6 are placed a predetermined distance between the point and bend of the hook. The two barbs 5 & 6 are angled away from the point 4 to provide two sharp points for the hook to pierce and engage the fish after penetration thereby preventing the hook from exiting the initial entry point during retrieval of the fish. The barbs are of equal length featuring a common angle and bend.

FIG. 4 demonstrates that the barbs 5 & 6 are placed on either side of the primary wire shaft and bent toward the shank 2. This positioning allows the barbs 5 & 6 to be cut or made using material on either side of the hook, allowing for longer curved barbs without impacting the structure or strength of the hook bend 3.

The barbs 5 & 6 are located on either side of the hook wire or shaft at an angle of 180 degrees to each other, and the point at which the barbs 5 & 6 are connected to the wire or shaft of the hook is perpendicular to the shank 2.

As a fish caught by the mouth may generally exert a strong pulling force on the bend of a hook, this invention retains as much material strength as possible while providing an increased potential for a strong engagement with the tissue of the fish, and thereby result in a higher likelihood of completing the retrieval of the fish.

Having described my invention, I claim:

1. A fish hook with two barbs emanating from either side of the hook shaft located to the side of the shaft between the point and the hook bend.
a. Two barbs are of equal length, angle, and bend
b. Located on either side of the hook wire or shaft at an angle of 180 degrees to each other, perpendicular to the shank.
